(19) United States
(12) Patent Application Publication
(10) Pub. No.: US 2007/0022405 A1
(43) Pub. Date: Jan. 25, 2007

(54) Method and system for software design

(75) Inventor: Steven C. Bray, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/187,900

(22) Filed: Jul. 25, 2005

Related U.S. Application Data
(63) Continuation-in-part of application No. 11/184,823, filed on Jul. 20, 2005, now abandoned.

(51) Int. Cl. G06F 9/44

(52) U.S. Cl. 717/106

(57) ABSTRACT

A method and system are disclosed for automatically generating instructions for a computing device. The method includes receiving user input related to the instructions, automatically generating data source code based on the user input, automatically compiling the data source code to generate data object code, and automatically linking the data object code with functional object code to generate the instructions. The functional object code is compiled and validated prior to receiving the user input.

This application is a continuation-in-part of Application No. ______, entitled “METHOD AND SYSTEM FOR SOFTWARE DESIGN,” filed Jul. 20, 2005.

### TECHNICAL FIELD

The present disclosure relates to software development systems and methods and, more particularly, a system and method for automatically generating software instructions for a work machine controller.

### BACKGROUND

Software instructions can be designed using a computer-generated design environment. A design environment may include a system design tool that facilitates a function-based approach to designing software, and a database that stores functional blocks of software available to the design tool for generating the software instructions. Designing functional blocks to be reusable in any application is a principle of object-oriented software design. Thus, each functional block identified in the database may have been developed previously for use in an entirely separate system and each may perform a particular function.

In operation, a system design tool may present a graphical user interface (GUI) to a user, and through the GUI, the design tool may accept user input indicating a plurality of sub-functions that the system would have to perform in order to perform the overall function of the system. The user input may also indicate types of interaction between the sub-functions. The design tool may then identify from the database the functional blocks that can perform the inputted sub-functions, and may conceptually build a graphical representation of the software instructions by connecting the identified functional blocks according to the inputted interaction of the sub-functions. The database identifying the software blocks is often referred to as a catalog or library.

At least one system is known for developing software instructions based on reusable functional blocks. For example, U.S. Patent Application Publication No. 2004/0168152 (“the '152 application”), listing Kramer as inventor and published on Aug. 26, 2004, describes an enterprise system or software development system for determining or checking for dependencies between software components. Particularly, the system of the '152 application includes a tool for defining rules that allow, forbid, or constrain certain dependencies between software objects or modules within a large-scale software project. When the large-scale software project is built, for example at compile time, the dependencies can be checked and verified against the rules.

While the system of the '152 application may be effective for managing dependencies between software modules within large-scale software projects, the system of the '152 application includes several disadvantages. For example, the system requires deployment of all software instructions, including functional blocks, in one executable and, therefore, a user cannot readily add additional functionality. Moreover, the tool disclosed by the '152 application generates an executable including software instructions that may ultimately never be used, which is inefficient and increases the time required to compile and deploy the software instructions.

Other conventional systems for developing software instructions generate a substantial portion of the required source code based on user input. Systems of this type typically require a complex code generator and fail to take advantage of reusable code that has been compiled and validated prior to receiving user input.

The present disclosure is directed to overcoming one or more of the problems or disadvantages existing in the prior art.

### SUMMARY OF THE INVENTION

One disclosed embodiment includes a method for automatically generating instructions for a computing device. The method includes receiving user input related to the instructions, automatically generating data source code based on the user input, automatically compiling the data source code to generate data object code, and automatically linking the data object code with functional object code to generate the instructions. The functional object code may be compiled and validated prior to receiving the user input.

A second disclosed embodiment includes a system for automatically generating instructions for a computing device. The system may include a user interface for receiving user input related to the instructions, a library for storing functional object code, and a processor. The processor may include a data source code generator for automatically generating data source code based on the user input, a compiler for compiling the data source code to generate data object code, and a linker for automatically linking the data object code with functional object code that is selected from the library based on the user input. The functional object code may be compiled and validated prior to receiving the user input.

### BRIEF DESCRIPTION OF THE DRAWINGS

FIG. 1 provides a diagrammatic illustration of a system, according to an exemplary disclosed embodiment.

FIG. 2 provides a view of a console within the system of FIG. 1, according to an exemplary disclosed embodiment.

FIG. 3 provides a flow chart of an exemplary method that may be performed by the disclosed system.

### DETAILED DESCRIPTION

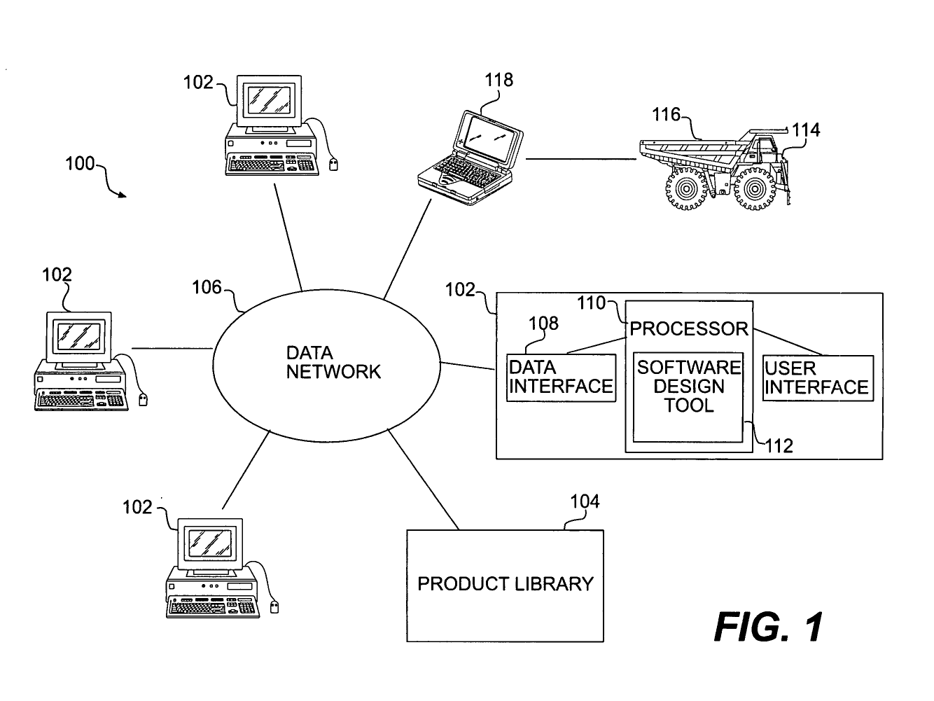

FIG. 1 is a diagrammatic illustration of a system 100 for automatically generating instructions for a computing device. System 100 may include various consoles 102 and a product library 104 for storing reusable functional blocks of object code. Each of consoles 102 and product library 104 may be operably connected to each other via a data network 106.

Console 102 may include a data interface 108 and a processor 110 for running a software design tool 112. Software design tool 112 may be used to design and automatically generate instructions for a computing device, such as a work machine controller 114 on board a work machine 116. Work machine controller 114 may be, for example, a processor for controlling an engine system, an on-board electrical or communications system, a hydraulic system, or various other systems associated with work machine 116.

System 100 may also include a service tool 118 to transfer automatically generated instructions designed to run on work machine controller 114. Software applications may be periodically improved or changed and transferred as updates from service tool 118 to work machine controller 114.

Product library 104 may include previously compiled and verified functional object code as various functional blocks of object code. The functional blocks of object code may be verified against a set of interface constraints to facilitate reuse in generating instructions to run on work machine controllers, such as work machine controller 114. For example, if a new work machine controller is installed or work machine controller 114 is modified on work machine 116, a portion of the functional blocks of object code used in work machine controller 114 may be reused with little or no modification. For example, a functional block of object code may carry out a common function such as implementing a clutch algorithm. In addition, common functions may be designed, compiled, and verified once and used thereafter in multiple work machine controllers, thereby streamlining development and deployment of instructions.

Software design tool 112 running on one of consoles 102 may provide user access to product library 104. Thus, a user of software design tool 112 may select reusable functional blocks of object code from a menu for use in designing and automatically generating instructions to run on work machine controller 114. A menu displayed by software design tool 112 may present a selection of functional blocks of object code organized by various categories, such as parts of a work machine associated with particular functions. A menu may also organize sub-functions under broader functions and may permit selection of a group of functional blocks of object code required for implementing one or more sub-functions. Software design tool 112 may also permit searches for functional blocks of object code within product library 104 based on user-specified criteria. Furthermore, while FIG. 1 depicts product library 104 as being remote from consoles 102, product library may also be stored in a product library local to one of consoles 102.

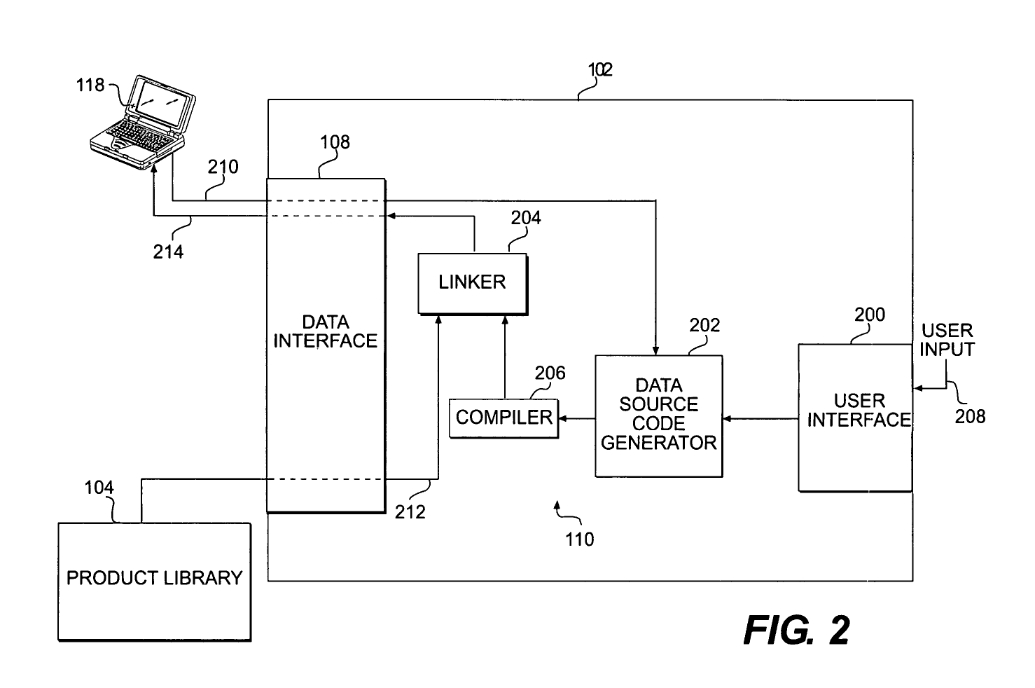

FIG. 2 provides an exemplary view of console 102 and its various functional components. Console 102 may include a user interface 200, a processor 110, and a data (i.e., network) interface 108. A software design tool may be loaded on processor 110. Processor 110, running software design tool 112, may include a data source code generator 202, a linker 204, and a compiler 206.

User interface 200 may receive user input 208 related to instructions for execution on work machine controller 114. User input 208 may include, for example, a selection of functional blocks of object code from product library 104 and a selection of connections between the selected functional blocks of object code. User interface 200 may provide appropriate graphical representations of the selected functional blocks of object code and selected connections. User interface 200 may also provide options for saving, loading, and printing of graphical representations.

Data source code generator 202 may automatically generate data source code based on user input 208 received from user interface 200. The data source code may contain numeric values representing the user-defined selection and configuration of functional blocks of object code. The data source code may include individual data blocks of source code corresponding to individual functional blocks of object code. For example, a functional block of object code may represent a gain amplifier. A corresponding data block of source code may include an associated numerical gain value. Data source code generator 202 may also receive, via data interface 108, system parameters 210 associated with a platform, such as work machine controller 114. Thus, the data source code may also contain numeric values representing system parameters 210.

Compiler 206 may compile the data source code to generate data object code. Compiler 206 may be an inexpensive or suboptimal compiler because it may be designed to compile only data source code and no functional source code. Thus, compiler 206 may be an open-source compiler, for example.

Linker 204 may receive the data object code from compiler 206. Linker 204 may also receive, via data interface 108, a set of functional blocks of object code 212 that have been selected based on user input 208 from product library 104. Linker 204 may generate a distributed library containing selected functional blocks of object code 212 and may automatically link the data object code to selected functional blocks of object code 212 in the distributed library to generate instructions 214 for execution on work machine controller 114. For example, linker 204 may generate and put symbolic references in the data object code. The symbolic references may point to appropriate memory locations associated with the distributed library containing selected functional blocks of object code 212.

Linker 204 may transfer instructions 214 to service tool 118 via data interface 108. Later, if a user desires to modify instructions 214, the user may load a graphical representation associated with instructions 214 and make any desired modifications or additions. Thus, a portion of or all of selected functional blocks of object code 212 may be retained in a new set of instructions

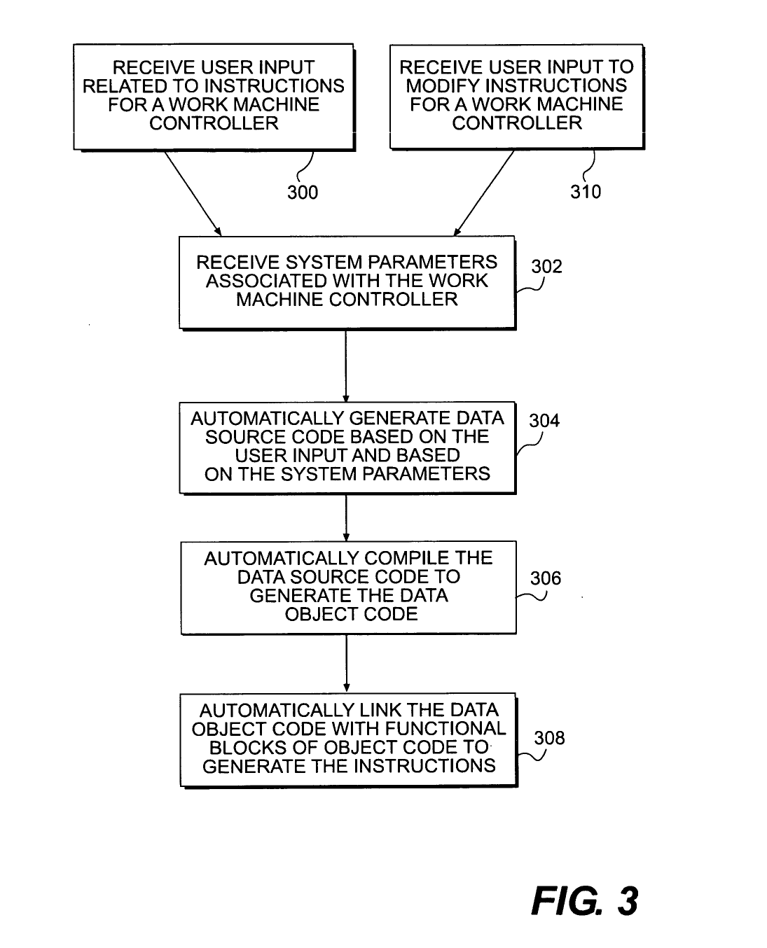

FIG. 3 provides an illustration of an exemplary method that may be carried out by console 102 to generate instructions 214 for execution on work machine controller 114. The method may start at step 300. In step 300, user interface 200 may receive user input 208 related to instructions 214. In step 302, data source code generator 202 may receive system parameters associated with a platform, such as work machine controller 114 for implementing instructions 214. Step 304 includes automatically generating data source code based on user input 208 and based on system parameters 210. Step 306 includes automatically compiling the data source code to generate data object code. Finally, in step 208, the data object code is automatically linked with functional object code to generate instructions 214. The data object code may be linked with selected functional blocks of object code 212 that are selected based on user input 208. Linking may be accomplished by generating and putting symbolic references in the data object code for pointing to a memory location associated with the selected functional blocks of object code 212.

Alternatively, the exemplary method may begin with step 310, which includes receiving user input 208 to modify instructions 214. For example, a user may make modifications or additions to a previously designed graphical representation associated with instructions 214. A portion or all of selected functional blocks of object code 212 may be retained when generating a new set of instructions. Step 302 through step 308 may then be carried out as described above to generate a new set of instructions.

### INDUSTRIAL APPLICABILITY

The disclosed system and method for automatically generating instructions for a computing device may be used to develop software to run on any platform. In one exemplary disclosed embodiment, the system and method may be used to develop software to run on a work machine controller.

The presently disclosed system and method for automatically generating instructions for a computing device have several advantages. First, the disclosed system and method do not compile any functional source code. This is accomplished by reusing functional blocks of object code previously compiled, validated, and stored in product library 104. Thus, the complexity of the system and the complexity of using the system to automatically generate software is greatly reduced as compared to conventional systems. Moreover, unlike conventional systems that generate one executable including multiple functions, the disclosed system and method permit adding or removing a function by adding or removing only the executable code corresponding to the function. This feature makes the deployment of updated software much quicker and more efficient.

It will be apparent to those skilled in the art that various modifications and variations can be made in the disclosed system and method for automatically generating software instructions without departing from the scope of the disclosure. Additionally, other embodiments of the disclosed system will be apparent to those skilled in the art from consideration of the specification. It is intended that the specification and examples be considered as exemplary only, with a true scope of the disclosure being indicated by the following claims and their equivalents.

What is claimed is:

1. A method for automatically generating instructions for a computing device, the method comprising:
receiving user input related to the instructions;
automatically generating data source code based on the user input;
automatically compiling the data source code to generate data object code; and
automatically linking the data object code with functional object code to generate the instructions,
wherein the functional object code is compiled and validated prior to receiving the user input.

2. The method of claim 1, wherein the user input selects the functional object code from a library of functional object code.

3. The method of claim 2, wherein a processor for automatically generating the data source code is local to the library of functional object code.

4. The method of claim 2, wherein a processor for automatically generating the data source code is adapted to access the library of functional object code through a network interface.

5. The method of claim 1, further including:
receiving system parameters associated with a platform for implementing the instructions.

6. The method of claim 5, wherein automatically generating the data source code includes automatically generating the data source code based on the system parameters.

7. The method of claim 5, wherein the platform is a work machine controller.

8. The method of claim 1, wherein automatically linking the data object code includes putting symbolic references in the data object code for pointing to a memory location of the functional object code.

9. The method of claim 1, wherein the generated instructions include a first set of instructions, and the functional object code is adapted to be used in generating a second set of instructions.

10. The method of claim 1, wherein the generated instructions include a first set of instructions, and the functional object code includes a first set of functional object code, the method further including:
receiving user input to modify the first set of instructions to include functionality associated with a second set of functional object code.

11. The method of claim 10, wherein the data source code includes a first set of data source code and the data object code includes a first set of data object code, the method further including:
automatically generating a second set of data source code based on the user input to modify the first set of instructions;
automatically compiling the second set of data source code to generate a second set of data object code; and
automatically linking the second set of data object code with the first and second sets of functional object code,
wherein the second set of functional object code is compiled and validated prior to receiving the user input to modify the first set of instructions.

12. A system for automatically generating instructions for a computing device, the system comprising:
a user interface for receiving user input related to the instructions;
a library for storing functional object code; and
a processor including:
a data source code generator for automatically generating data source code based on the user input;
a compiler for automatically compiling the data source code to generate data object code; and
a linker for automatically linking the data object code with functional object code that is selected from the library based on the user input,
wherein the functional object code is compiled and validated prior to receiving the user input.

13. The system of claim 12, wherein the library is local to the processor.

14. The system of claim 12, wherein the library is remote from the processor, and the processor is adapted to interface with a network interface for remotely accessing the library.

15. The system of claim 12, further including a data interface adapted to receive system parameters.

16. The system of claim 15, wherein the data source code generator is adapted to automatically generate the data source code based on the system parameters.

17. The system of claim 15, wherein the system parameters are associated with a work machine controller configured to implement the instructions.

18. The system of claim 12, wherein the linker is adapted to put symbolic references in the data object code for pointing to a memory location associated with the functional object code.

19. The system of claim 12, wherein the generated instructions include a first set of instructions, and the functional object code is adapted to be included in a second set of instructions.

20. The system of claim 19, wherein the functional object code includes a first set of functional object code, and the user interface is adapted to permit selection of a second set of functional object code to include in the second set of instructions.
